(19) United States
(12) Patent Application Publication
(10) Pub. No.: US 2021/0149800 A1
(43) Pub. Date: May 20, 2021

(54) SSD SYSTEM USING POWER-CYCLE BASED READ SCRUB

(71) Applicant: Western Digital Technologies, Inc., San Jose, CA (US)

(72) Inventors: Niles Yang, Mountain View, CA (US); Lior Avital, San Jose, CA (US); Mrinal Kochar, San Jose, CA (US); Daniel Linnen, San Jose, CA (US); Rohit Sehgal, San Jose, CA (US)

(73) Assignee: Western Digital Technologies, Inc., San Jose, CA (US)

(21) Appl. No.: 16/689,693

(22) Filed: Nov. 20, 2019

(51) Int. Cl. G06F 12/0804; G06F 11/14

(52) U.S. Cl. CPC G06F 12/0804; G06F 2212/1032; G06F 2201/815; G06F 11/1446

(57) ABSTRACT

A system and method for a power-cycle based read scrub of a memory device is provided. A controller stores an access counter which indicates a number of times a logical block address (LBA) has been accessed. When the LBA is accessed, the LBA counter is incremented. If the LBA counter indicates a count higher than a predetermined count, data stored in the LBA is duplicated and the duplicate data is stored as backup data. Subsequent access of the LBA will show that the LBA count is higher than the predetermined count, so the backup data will be accessed rather than the original LBA, thus preventing read-induced failure of the data which may be caused by further repeated access of the same LBA.

### BACKGROUND

### Technical Field

Apparatuses and methods relate to a solid state drive (SSD) system and method, and more particularly to a power-cycle based read scrub method and apparatus.

### Description of the Related Art

3D NAND flash memory is a type of non-volatile flash memory in which memory cells are stacked vertically in multiple layers. 3D NAND was developed to address challenges encountered in scaling two dimensional (2D) NAND technology to achieve higher densities at a lower cost per bit.

A memory cell is an electronic device or component capable of storing electronic information. Non-volatile memory may utilize floating-gate transistors, charge trap transistors, or other transistors as memory cells. The ability to adjust the threshold voltage of a floating-gate transistor or charge trap transistor allows the transistor to act as a non-volatile storage element (i.e., a memory cell), such as a single-level cell (SLC), which stores a single bit of data. In some cases more than one data bit per memory cell can be provided (e.g., in a multi-level cell) by programming and reading multiple threshold voltages or threshold voltage ranges. Such cells include a multi-level cell (MLC), storing two bits per cell; a triple-level cell (TLC), storing three bits per cell; and a quad-level cell (QLC), storing four bits per cell.

FIG. 1 is a diagram of an example 3D NAND memory array 260. In this example, the memory array 100 is a 3D NAND memory array. However, this is just one example of a memory array. The memory array 260 includes multiple physical layers that are monolithically formed above a substrate 34, such as a silicon substrate.

Storage elements, for example memory cells 301, are arranged in arrays in the physical layers. A memory cell 301 includes a charge trap structure 44 between a word line 300 and a conductive channel 42. Charge can be injected into or drained from the charge trap structure 44 by biasing the conductive channel 42 relative to the word line 300. For example, the charge trap structure 44 can include silicon nitride and can be separated from the word line 300 and the conductive channel 42 by a gate dielectric, such as a silicon oxide. An amount of charge in the charge trap structure 44 affects an amount of current through the conductive channel 42 during a read operation of the memory cell 301 and indicates one or more bit values that are stored in the memory cell 301.

The 3D memory array 260 includes multiple blocks 80. Each block 80 includes a “vertical slice” of the physical layers that includes a stack of word lines 300. Multiple conductive channels 42 (having a substantially vertical orientation, as shown in FIG. 1) extend through the stack of word lines 300. Each conductive channel 42 is coupled to a storage element in each word line 300, forming a NAND string of storage elements, extending along the conductive channel 42. FIG. 1 is three blocks 80, five word lines 300 in each block 80, and three conductive channels 42 in each block 80 for clarity of illustration. However, the 3D memory array 260 can have more than three blocks, more than five word lines per block, and more than three conductive channels per block.

Physical block circuitry 450 is coupled to the conductive channels 42 via multiple conductive lines: bit lines, illustrated as a first bit line BL0, a second bit line BL1, and a third bit line BL2 at a first end of the conductive channels (e.g., an end most remote from the substrate 34) and source lines, illustrated as a first source line SL0, a second source line SL1, and a third source line SL2, at a second end of the conductive channels (e.g., an end nearer to or within the substrate 234). The physical block circuitry 450 is illustrated as coupled to the bit lines BL0-BL2 via “P” control lines, coupled to the source lines SL0-SL2 via “M” control lines, and coupled to the word lines via “N” control lines. Each of P, M, and N can have a positive integer value based on the specific configuration of the 3D memory array 260.

Each of the conductive channels 42 is coupled, at a first end to a bit line BL, and at a second end to a source line SL. Accordingly, a group of conductive channels 42 can be coupled in series to a particular bit line BL and to different source lines SL.

It is noted that although each conductive channel 42 is illustrated as a single conductive channel, each of the conductive channels 42 can include multiple conductive channels that are in a stack configuration. The multiple conductive channels in a stacked configuration can be coupled by one or more connectors. Furthermore, additional layers and/or transistors (not illustrated) may be included as would be understood by one of skill in the art.

When a memory system remains powered-up for an extended period of time, typically, a number of policies are executed, such as garbage collection, wear leveling, read-scrub, and read disturb. When a solid state device (SSD) only experiences power-ups, followed quickly by power-downs, then these steady-state/run-time policies may not be able to be fully executed, causing problems. More specifically, when there are repeated power-ups within short period of time, for example, thousands of power-up cycles and cold boot cycles as rapidly as is per power cycle, there is insufficient time between power-ups to execute the needed policies. New or modified policies are needed to address such issues.

### SUMMARY

Example embodiments may address at least the above problems and/or disadvantages and other disadvantages not described above. Also, example embodiments are not required to overcome the disadvantages described above, and may not overcome any of the problems described above.

One or more example embodiments may provide a power-cycle based read scrub which protects data stored at an originally-accessed logical block address (LBA) from read-induced damage and/or failure due to excessive reads.

According to an aspect of an example embodiment, a method of identifying a read disturbance of a memory device is provided. The method includes powering-on the memory device and determining a power-on count that is a number of times that the memory device has been powered-on since a last time data was written. If the power-on count is equal to or greater than a first predetermined number, it is then determined whether there is an uncorrectable error. If there is an uncorrectable error, failure statistics are recorded, and a read disturbance is identified at the location of the uncorrectable error.

When the device is powered on, writing to the memory device may also be performed, as well as a write, read, compare operation. The memory device may then be powered-off and powered-on again.

If, when the power-on count is equal to or greater than the first predetermined number, it is determined that there no uncorrectable error, the memory device may be powered-off and the method may then be repeated.

According to an aspect of another example embodiment, a power-cycle based read scrub method of a memory device is provided. First, the memory device is powered-on, and an original logical block address (LBA) to be read is identified. It is then determined whether an LBA access count is greater than or equal to a predetermined count. If the LBA access count is less than the predetermined count, the original LBA is accessed and the LBA access count is incremented by one.

If the LBA access count is greater than the predetermined amount, rather than the original LBA being accessed, backup data comprising a duplicate of data stored in the original LBA may be accessed.

Ultimately, the LBA counter may be flushed and the memory device may be powered-off. A backup operation comprising a read scrub operation on a physical block address (PBA) corresponding to the original LBA may also be performed.

Once the LBA access count is incremented, if it is greater than the predetermined count, the data of the original LBA may be duplicated and stored as backup/duplicate data in one of a single-level cell (SLC) block, a triple-level cell (TLC) block, and a quad-level cell (QLC) block. Data in one or more physical block addresses (PBAs) surrounding the original LBA may also be duplicated and stored as backup data.

According to an aspect of another example embodiment, a non-volatile memory system is provided, comprising a memory controller comprising a first port configured to couple to a host device and a second port configured to couple to a memory array. The memory controller is configured to power-on a memory device upon control from the host device, to identify an original logical block address (LBA) of the memory array to be read; to determine whether an LBA access count is greater than or equal to a predetermined count; and if the LBA access count is less than the predetermined count, read the original LBA and increment the LBA access count by one.

If the LBA access count is greater than the predetermined amount, the memory controller may read backup data comprising a duplicate of data stored in the original LBA.

The memory controller may also perform a backup operation comprising a read scrub operation on a physical block address (PBA) corresponding to the original LBA; flush the LBA counter and block information; and power-off the memory device.

The memory controller may also determine if the incremented LBA access count is greater than the predetermined count. If the incremented LBA access count is greater than the predetermined count, the memory controller may duplicate the data of the original LBA and store the duplicate data as backup data in one of a single-level cell (SLC) block, a triple-level cell (TLC) block, and a quad-level cell (QLC) block. The memory controller may further duplicate data in one or more physical block addresses (PBAs) surrounding the original LBA and store the duplicated data of the one or more PBAs as backup data.

### BRIEF DESCRIPTION OF THE DRAWINGS

The above and/or other aspects will become apparent and more readily appreciated from the following description of example embodiments, taken in conjunction with the accompanying drawings in which:

FIG. 1 is a diagram of an example 3D NAND memory;

FIG. 2 is a block diagram of an example system architecture;

FIG. 3 is a flow chart of a method of confirming a power cycle and read disturbance scenario, of an example embodiment;

FIG. 4 is a Vt distribution illustrating a read disturb indication, of an example embodiment;

FIG. 5 is a flow chart of a power-cycle based read scrub method, of an example embodiment; and

FIG. 6 is a block diagram of a 3D NAND system of an example embodiment.

### DETAILED DESCRIPTION

Reference will now be made in detail to example embodiments which are illustrated in the accompanying drawings, wherein like reference numerals refer to like elements throughout. In this regard, the example embodiments may have different forms and may not be construed as being limited to the descriptions set forth herein.

It will be understood that the terms “include,” “including”, “comprise, and/or “comprising,” when used in this specification, specify the presence of stated features, integers, steps, operations, elements, and/or components, but do not preclude the presence or addition of one or more other features, integers, steps, operations, elements, components, and/or groups thereof.

It will be further understood that, although the terms “first,” “second,” “third,′ etc., may be used herein to describe various elements, components, regions, layers and/or sections, these elements, components, regions, layers and/or sections may not be limited by these terms. These terms are only used to distinguish one element, component, region, layer or section from another element, component, region, layer or section.

As used herein, the term “and/or” includes any and all combinations of one or more of the associated listed items. Expressions such as “at least one of,” when preceding a list of elements, modify the entire list of elements and do not modify the individual elements of the list. In addition, the terms such as “unit,” “-er (-or),” and “module” described in the specification refer to an element for performing at least one function or operation, and may be implemented in hardware, software, or the combination of hardware and software.

Various terms are used to refer to particular system components. Different companies may refer to a component by different names—this document does not intend to distinguish between components that differ in name but not function.

Matters of these example embodiments that are obvious to those of ordinary skill in the technical field to which these example embodiments pertain may not be described here in detail.

This description references 3D NAND memory devices. However, it should be understood that the description herein may be likewise applied to other memory devices.

As used herein, the term “memory” denotes semiconductor memory. Types of semiconductor memory include volatile memory and non-volatile memory. Non-volatile memory allows information to be stored and retained even when the non-volatile memory is not connected to a source of power (e.g., a battery). Examples of non-volatile memory include, but are not limited to, flash memory (e.g., NAND-type and NOR-type flash memory), Electrically Erasable Programmable Read-Only Memory (EEPROM), ferroelectric memory (e.g., FeRAM), magneto-resistive memory (e.g., MRAM), spin-transfer torque magnetic random access memory (STT-RAM or STT-MRAM), resistive random access memory (e.g., ReRAM or RRAM) and phase change memory (e.g., PRAM or PCM).

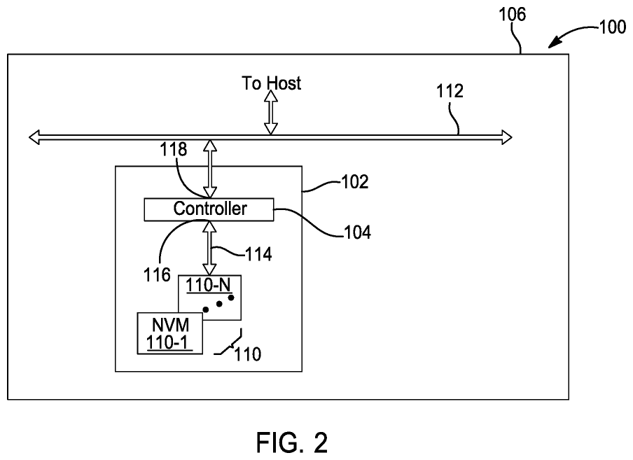

FIG. 2 is a block diagram of an example system architecture 100 including non-volatile memory 110. In particular, the example system architecture 100 includes a storage system 102 that further includes a controller 104 communicatively coupled to a host 106 by a bus 112. The bus 112 implements any known or after developed communication protocol that enables the storage system 102 and the host 106 to communicate. Some non-limiting examples of a communication protocol include Secure Digital (SD) protocol, Memory Stick (MS) protocol, Universal Serial Bus (USB) protocol, and Advanced Microcontroller Bus Architecture (AMBA).

The controller 104 has at least a first port 116 coupled to the non-volatile memory (NVM) 110, by way of a communication interface 114. The memory 110 is disposed within the storage system 102. The controller 114 couples the host 106 by way of a second port 118 and the bus 112. The first and second ports 116 and 118 of the controller may each include one or more channels that couple to the memory 110 or the host 106, respectively.

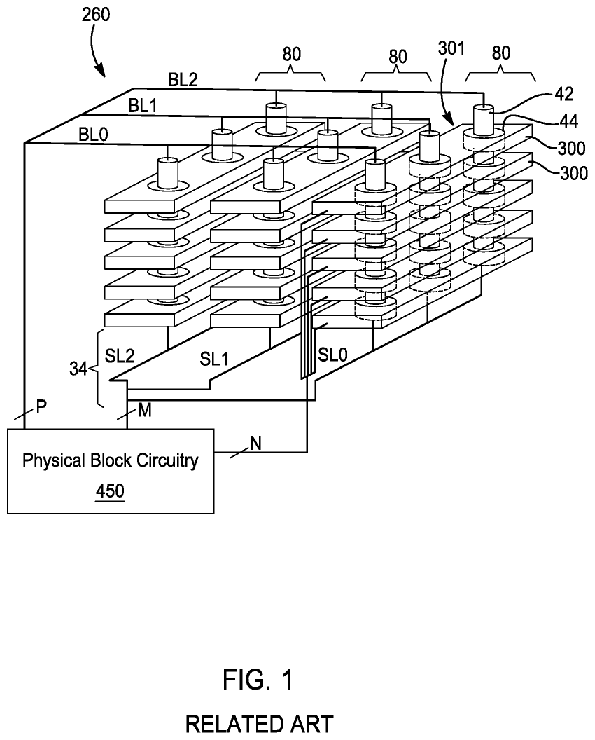

The memory 110 of the storage system 102 includes several memory die 110-1-110-N. The manner in which the memory 110 is defined with respect to FIG. 2 is not meant to be limiting. In some example embodiments, the memory 110 defines a physical set of memory die, such as memory die 110-1-110-N. In other example embodiments, the memory 110 defines a logical set of memory die, where the memory 110 includes memory die from several physically different sets of memory die. The memory die 110 include non-volatile memory cells, such as, for example, those described above with respect to FIG. 1, that retain data even when there is a disruption in the power supply. Thus, the storage system 102 can be easily transported and the storage system 102 can be used in memory cards and other memory devices that are not always connected to a power supply.

In various example embodiments, the memory cells in the memory die 110 are solid-state memory cells (e.g., flash), one-time programmable, few-time programmable, or many time programmable. Additionally, the memory cells in the memory die 110 may include single-level cells (SLC), multiple-level cells (MLC), triple-level cells (TLC), or quad-level cells (QLC). In one or more example embodiments, the memory cells may be fabricated in a planar manner (e.g., 2D NAND flash) or in a stacked or layered manner (e.g., 3D NAND flash).

The controller 104 and the memory 110 are communicatively coupled by an interface 114 implemented by several channels (e.g., physical connections) communicatively coupled between the controller 104 and the individual memory die 110-1 through 110-N. The depiction of a single interface 114 is not meant to be limiting as one or more interfaces may be used to communicatively couple the same components. The number of channels over which the interface 114 is established may vary based on the capabilities of the controller 104. Additionally, a single channel may be configured to communicatively couple more than one memory die. Thus the first port 116 may couple one or several channels implementing the interface 114. The interface 114 implements any known or after developed communication protocol. In example embodiments in which the storage system 102 is a flash memory, the interface 114 is a flash interface, such as Toggle Mode 200, 400, or 800, or Common Flash Memory Interface (CFI).

In one or more example embodiments, the host 106 may include any device or system that utilizes the storage system 102—e.g., a computing device, a memory card, a flash drive. In some example embodiments, the storage system 102 is embedded within the host 106—e.g., a solid state disk (SSD) drive installed in a laptop computer. In additional embodiments, the system architecture 100 is embedded within the host 106 such that the host 106 and the storage system 102 including the controller 104 are formed on a single integrated circuit chip. In example embodiments in which the system architecture 100 is implemented within a memory card, the host 106 may include a built-in receptacle or adapters for one or more types of memory cards or flash drives (e.g., a USB port, or a memory card slot).

Although, the storage system 102 includes its own memory controller and drivers (e.g., controller 104), the example described in FIG. 2 is not meant to be limiting. Other example embodiments of the storage system 102 include memory-only units that are instead controlled by software executed by a controller on the host 106 (e.g., a processor of a computing device controls—including error handling of—the storage unit 102). Additionally, any method described herein as being performed by the controller 104 may also be performed by the controller of the host 106.

Still referring to FIG. 2, the host 106 includes its own controller (e.g., a processor) configured to execute instructions stored in the storage system 102, and the host 106 accesses data stored in the storage system 102, referred to herein as “host data.” The host data includes data originating from and pertaining to applications executed on the host 106. In one example, the host 106 accesses host data stored in the storage system 102 by providing a logical address (e.g. a logical block address (LBA)) to the controller 104 which the controller 104 converts to a physical address (e.g. a physical block address (PBA)). The controller 104 accesses the data or particular storage location associated with the PBA and facilitates transfer of data between the storage system 102 and the host 106. Of one or more example embodiments in which the storage system 102 includes flash memory, the controller 104 formats the flash memory to ensure the memory is operating properly, maps out bad flash memory cells, and allocates spare cells to be substituted for future failed cells or used to hold firmware to operate the flash memory controller (e.g., the controller 104). Thus, the controller 104 may perform any of various memory management functions such as wear leveling (e.g., distributing writes to extend the lifetime of the memory blocks), garbage collection (e.g., moving valid pages of data to a new block and erasing the previously used block), and error detection and correction (e.g., read error handling).

As discussed above, repeated power cycles of an SSD within a short period of time may cause problems which result from insufficient time for executing needed policies.

In certain situations, whenever a memory system is powered-up, the platform reads the same LBA location. This means that with respect to the same drive, the same physical location is repeatedly being accessed during system power-up. A problem caused by this is that when there are repeated power-cycles within short period of time, for example, thousands of power-up cycles and cold boot cycles as rapidly as is per power cycle, there is insufficient time between power-cycles to address and fix any issues at the LBA caused by the intensive read operation. In other words, there is insufficient time to perform the existing counter-measure, called a read scrub, by means of which a scan is performed to locate and correct bit errors, in order to address the affected data before it causes a failure. A read scrub process includes a read scan, during which a memory drive itself performs a scan to determine locations of any bit errors. If, during a read scan, a location is found to have a high bit error rate (BER), it will be determined to relocate the data out of the high BER location.

However, in cases in which there may be as many as one second per power cycle, there is insufficient time for a read scrub, either to perform the read scrub at all or to cover the repeatedly-addressed LBA.

Identifying Read-Induced Errors in View of Repeated Power-Cycle Read Patterns.

Of one or more example embodiments, an intelligent read pattern recognition algorithm is used to identify and address repeated, very fast power-cycle read patterns, and thus effects data protection above and beyond the data that is protected by use of read scrub operations.

A statistical analysis of where the drive is read and a function to allow it to determine how many accesses have happened and thus whether a particularly intensive read scrub is needed in a particular area.

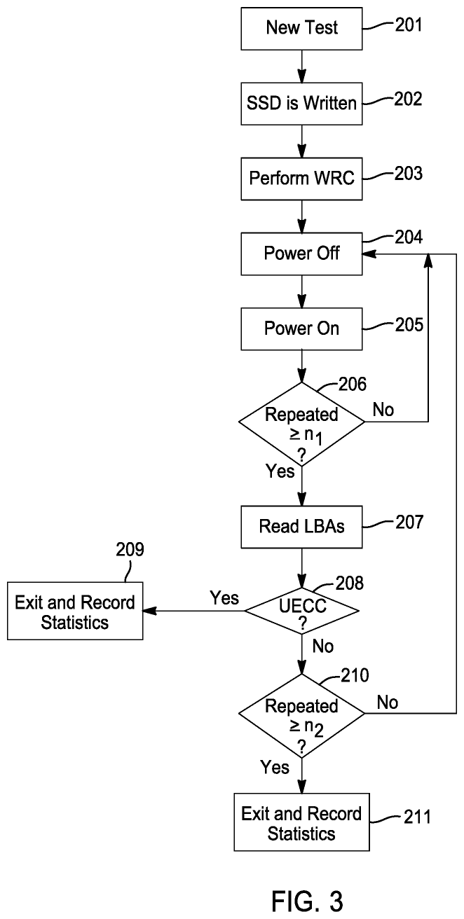

FIG. 3 is a flow chart of a method of confirming a power cycle and read disturbance scenario of an example embodiment.

When a memory system is written, a WRC (write, read, compare) is performed (202) in order to confirm accurate writing of the data. The WRC includes writing data in a fixed data pattern (202), reading from a particular location in the data pattern, and comparing the read data to the data written in that location to determine if the written data and the read data are identical. The written and read data should be identical.

Of the example embodiment of FIG. 3, a method is performed based on a WRC. As shown, after a WRC is performed (203), it is expected that the written data is good. The drive is then powered off (204) and, after a time, e.g. 1 second has passed, the drive is powered-on again (205). The operations of powering off (204) and powering on (205) are repeated a predetermined number of times n₁ (206). In this case, the predetermined number n₁ may be 100 times, or may be another number as would be understood by one of skill in the art. This effectively mimics what happens when a customer repeatedly powers on and off with power cycles of, for example, only 1 second.

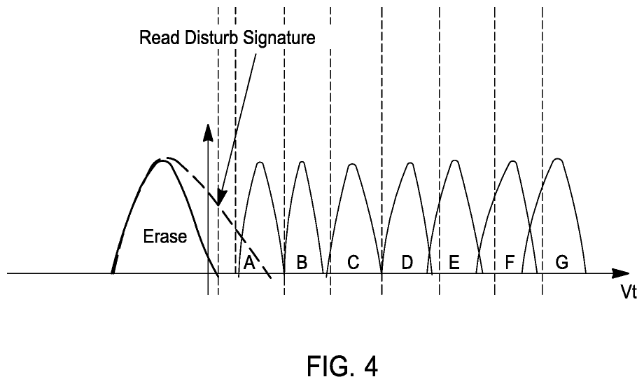

When the power-off (204)/power-on (205) cycle, has been performed has been performed fewer than n₁ times (206=NO), the cycle is repeated again. When the cycle has been performed n₁ times (206=YES), a particular LBA is read (207). It is noted that throughout this process of FIG. 2, this particular LBA does not change. The failure bit count (FBC) of this LBA is then determined. If it is determined that there is no uncorrectable error code correction (UECC) (208=NO), this cycle of operations (204-208) is repeated n₂ times (210). In this case n₂ may be 1000 or another number as would be understood by one of skill in the art. If it is determined that there is a UECC, meaning that the data is not decodable and is faulty beyond correction (208=YES), this means that the failure is due to a read-induced error, because the WRC (203), confirmed accurate writing of the data. In this case, the failing statistics are recorded (209). The cell Vt distribution (CVD) is collected from failing LBAs and from surrounding locations. Basically, the system collects the Vt distribution step-by-step, and the lowest state may show a hump that illustrates the read disturb effect, as shown in FIG. 4.

As shown in FIG. 4, after an erase operation, there is programming in states A-G, and as a particular location is repeatedly read, there will be a read disturb indication, as shown.

Once it is determined that the overall cycle has been performed n₂ times (210=YES), failing statistics are recorded (211).

A Power-Cycle-Based Read Scrub Method.

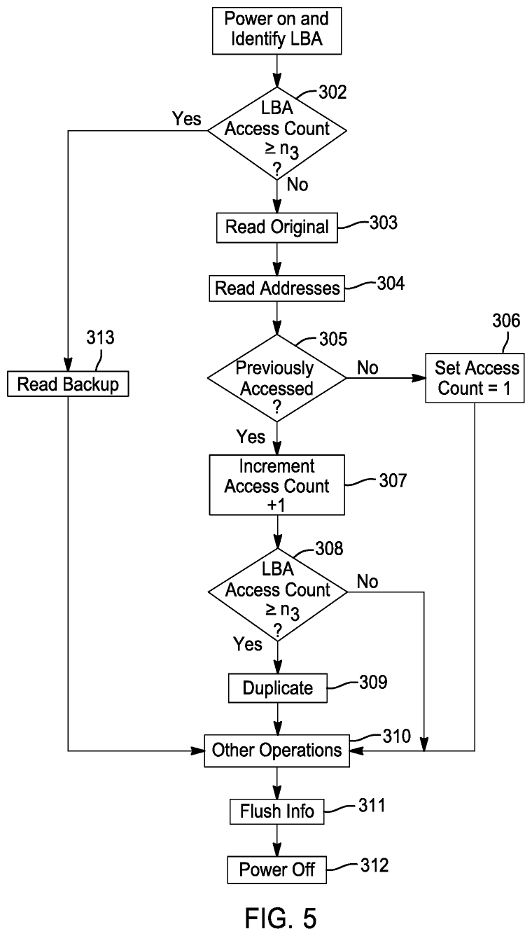

FIG. 5 is a flow chart of a power-cycle based read scrub method, of an example embodiment. In view of the possibility of a failure due to a read-induced error, as discussed with respect to FIG. 3, a method of FIG. 5 may be implemented in order to prevent such a failure.

Of this method, by way of overview, the SSD stores information regarding a number of times that an LBA is accessed in a power cycle. When a particular LBA has been accessed a predetermined number of times, e.g. 1000 times, a duplicate copy is made of the LBA and a range of addresses surrounding LBAs into a new “backup block.” Subsequently, when the original LBA is to be accessed, the backup is actually read, thereby “protecting” the original LBA data from repeated read access.

When there is a power-on at the beginning of a power cycle, a platform (e.g. personal computer) will access the SSD a first time for BiOS (built-in operating system) or bot purposes, and will initially identify a particular logic block address (LBA) to read. At this time, the SSD will be able to identify the LBA that the system is trying to read. A counter is built into the drive, indicating a number of times the particular LBA has been previously accessed.

Thus, when the drive is accessed, it is determined whether that LBA has been previously read, and if so, whether this LBA has been accessed more than a predetermined threshold number of times n₃ (302). The predetermined threshold n₃ may be 1000, for example, or may be another number as would be understood by one of skill in the art.

If it is determined that the LBA access count has not reached the threshold n₃ (302=NO), the drive will continue and read the LBA as originally stored (303). The drive records the accessed LBA and its associated physical block address (PBA) (304), and it is determined whether the accessed LBA has been previously accessed at power-on (305). If the LBA has not been previously accessed (305=NO), a counter is initially set to 1 (306), and the drive proceeds with other system operations (310), including, but not limited to, a read scrub operation. After the other operations, the LBA counter and block information is flushed (311) and the drive is powered-off (312).

If the LBA has been previously accessed (305=YES), the counter is incremented by one count (307), and it is determined whether the incremented counter has reached the predetermined threshold n₃ (308). If the counter has not reached the predetermined threshold n₃ (308=NO), the drive proceeds with other system operations (310), and ultimately flushes the LBA counter and block information (311) and powers off (312).

If the counter has reached the predetermined threshold n₃ (308=YES), a copy of the data in the PBA associated with the LBA, as well as the data in neighboring PBAs, is written into a new backup block. The neighboring PBAs may include one or more wordlines and/or strings adjacent to the original identified PBA associated with the LBA. The new backup block may be a new SLC block, which has a fast programming speed, or a new block, if the programming time is not critical. The original data is still valid, and not new XOR parity is created for the new blocks because of the time consumption required for new XOR parity handling. If time is available in a fast power cycle scenario, the new XOR handling may be performed.

When the drive is powered-on again, if the same LBA is again to be accessed, it is determined that the LBA counter has reached the threshold (302=YES). Then, rather than accessing the original LBA, the duplicate backup SLC, TLC, or QLC block is accessed (309), and any further access of the LBA is redirected to the backup. The data can be read correctly from the new SLC, TLC, or QLC block as it is refreshed, non-disturbed data. The original data at the original PBA is still valid. Thus, if there is a failure of the new, backup block, for example because there is no XOR parity built for it, the original data can still be read out from the original PBA. In such a case, a new duplicate may be created of the original data.

When there is an opportunity for a background operation (310) the system may run a formal read scrub on the original PBAs and conduct a read scrub relocation to refresh the data if needed, which may involve block level relocation even though only a fraction of the block is becoming vulnerable. In this case, the SLC block may be evicted.

Host-Side Mitigation of Read-Induced Errors.

Of another example embodiment, in addition to the operations of the embodiment of FIG. 5, a host may also be instructed to take steps to mitigate problems associated with repeated power-up reads of the same LBA. More specifically, a host may be instructed that the BiOS boot sector needs to be refreshed and/or that a BiOS update should be performed to relocate the LBA data and assign new LBAs for future BiOS operations to avoid data corruption. These operations with respect to the host may be performed in conjunction with or separately from the operations of the example embodiment of FIG. 5.

For example, upon determining that the incremented LBA access count is greater than the predetermined count (308, YES), the host may be instructed to refresh the BIOS boot sector and/or perform a BIOS update to relocate the data.

System

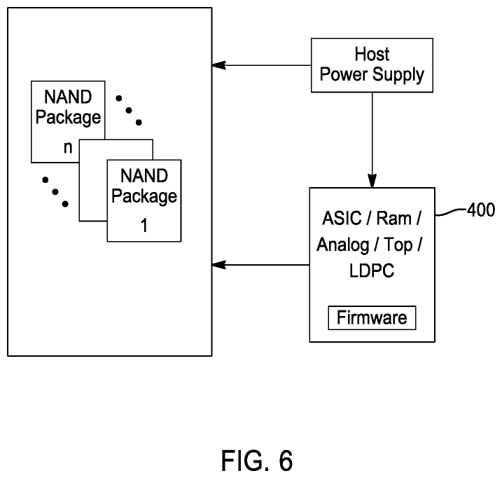

FIG. 6 is a block diagram of a NAND system including a circuitry module 400 that performs the operations of FIGS. 3 and 5, as discussed above. The circuitry module includes an Application-Specific Integrated Circuit (ASIC) performing the control operations and running associated firmware; a Low-Density Parity Check (LDPC), performing error decoding; random-access memory (RAM), and Analog Top circuitry. Although the ASIC, LDPC, RAM, and Analog Top circuitry are shown as a single module 400, the illustrated architecture is not meant to be limiting. For example, the ASIC, LDPC, RAM, and Analog Top circuitry may be separately located and connected via one or more busses. As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system.

As discussed above, when there are repeated power-ups of a memory system within a short period of time, there is likely insufficient time for implementation of necessary policies. Thus, one example embodiment provides a set of boot policies for the SSD that provide for: special handling of the LBAs that are initially accessed by the host; special handling of the last-written LBAs on safe shutdown, tracking of policy engagement, acceleration of policies based on engagement, and throttling to enable and/or enforce policy engagement. Solutions described herein may be used in combination with each other or individually.

Boot performance behavior tracking and analysis may include noting a boot token; noting the last LBA written; noting the first LBA read; comparing overlap between the last LBAs written and the first LBAs read to determine what might be worth caching for future boots; comparing the first read LBAs from a particular boot to those of previous boots to determine what should remain in a cache and what would be better relocated; looking at overlap of accessed LBAs to allow priority for caching based on how frequently an LBA is touched; noting an up-time token for early boot times (e.g. one token drop per 100 ms) in order to allow for a sense of up time on subsequent boots; noting the start of garbage collection, read scrub, read disturb, wear-leveling, and other NAND policies by particular tokens to allow for viewing the progress of NAND policies since each boot; noting read and write tokens as separate ones may be beneficial for host background activity; comparison of NAND policy actions by counting policy, time, and boot token metrics; and an all-clear token drop noting that the drive has progressed beyond boot into steady-state operation.

Such tokens may appear expensive, but may be very beneficial. Tokens trigger writes, thus reducing the likelihood of policy issues due to low rates of writes. Writes will force garbage collection, reduce partial block cases, and round out imbalanced read workloads, for example. Tokens are also only dropped in boot time. After a predetermined period of time, the tokens will stop being dropped, so that one might drop only a few MB of tokens per boot, depending on policies. Also tokens are driven by host activity, such as power cycling, reading/writing, and the like, so they will go into a host write location, but will not need to be garbage collected. Additionally, many tokens are being used for the purpose of checkpointing. In the case of a drive with hold-up caps, tokens could be reduced to the summary information of each boot.

Many drives have SLC caches associated with them for host writes in applications with burst workloads. These caches may also be utilized for boot performance policy implementation. Likewise, controllers typically have SRAM caches on them that would be used to accelerate boot performance.

To implement boot caching, a review of previous boot information could be used to provide a likely look ahead to the current boot, such that the LBAs first read in the previous boot could be pre-fetched into the controller and written into the SLC, if they didn't already exist there. The order of access of the LBAs could also be noted with respect to cases in which the controller memory is very limited in size relative to the boot request. This would allow for the replay of data, in the read order from the previous boot. Close attention could be paid to diminishing returns on this tracking and replaying. For example, tracking and replaying beyond 2 seconds or 100 MB might yield no additional benefit in cache hits.

Boot-targeted data could persist in the SLC cache and would not be targeted for folding, though, naturally, data that is not read would be subject to folding. As the data persists throughout the cycles, it could be distributed more evenly in the NAND to further boost performance. For example, data could be written in the order that it is read to allow for optimal fetching of data.

As the non-volatile cache would be SLC, this would inherently boost read-disturb performance.

In replaying the previous data and caching, regardless of host use, the data could be rewritten, so as to cycle the blocks.

It may be understood that the example embodiments described herein may be considered in a descriptive sense only and not for purposes of limitation. Descriptions of features or aspects within each example embodiment may be considered as available for other similar features or aspects in other example embodiments.

While example embodiments have been described with reference to the figures, it will be understood by those of ordinary skill in the art that various changes in form and details may be made therein without departing from the spirit and scope as defined by the following claims.

1.-5. (canceled)

6. A power-cycle based read scrub method of a memory device, the method comprising:
powering-on a memory device and identifying an original logical block address (LBA) to be read;
determining whether an LBA access count is greater than or equal to a predetermined count,
upon determining that the LBA access count is less than the predetermined count:
reading the original LBA, and
incrementing an LBA access counter, and
upon determining that the LBA access count is greater than the predetermined count, reading backup data comprising a duplicate of data stored in the original LBA.

7. The method of claim 6, further comprising:
flushing the LBA counter; and
powering-off the memory device.

8. The method of claim 6, further comprising:
performing a backup operation comprising a read scrub operation on a physical block address (PBA) corresponding to the original LBA.

9. A power-cycle based read scrub method of a memory device, the method comprising:
powering-on a memory device and identifying an original logical block address (LBA) to be read;
determining whether an LBA access count is greater than or equal to a predetermined count,
upon determining that the LBA access count is less than the predetermined count:
reading the original LBA, and
incrementing an LBA access counter, and
determining if the incremented LBA access count is greater than the predetermined count; and
upon determining that the incremented LBA access count is greater than the predetermined count, duplicating the data of the original LBA and storing the duplicate data as backup data.

10. The method of claim 9, wherein the storing the duplicate data as backup data comprises storing the duplicate data in one of a single-level cell (SLC) block, a triple-level cell (TLC) block, and a quad-level cell (QLC) block.

11. The method of claim 9, wherein the storing the duplicate data comprises duplicating data in one or more physical block addresses (PBAs) surrounding the original LBA and storing the duplicated data of the one or more PBAs as backup data.

12. The method of claim 9, further comprising:
performing a backup operation comprising a read scrub operation on a physical block address (PBA) corresponding to the original LBA.

13. The method of claim 12, further comprising:
flushing the LBA counter and block information; and
powering-off the memory device.

14. (canceled)

15. A non-volatile memory system comprising:
a memory controller comprising a first port configured to couple to a host device and a second port configured to couple a memory array;
wherein the memory controller is configured to
power-on the memory array upon control from the host device
identify an original logical block address (LBA) of the memory array to be read;
determine whether an LBA access count is greater than or equal to a predetermined count;
upon determining that the LBA access count is less than the predetermined count,
read the original LBA, and
increment an LBA access counter;
upon determining that the LBA access count is greater than the predetermined count, read backup data comprising a duplicate of data stored in the original LBA.

16. The system of claim 15, wherein the memory controller is further configured to:
perform a backup operation comprising a read scrub operation on a physical block address (PBA) corresponding to the original LBA.

17. The system of claim 16, wherein the memory controller is further configured to:
flush the LBA counter; and
power-off the memory array.

18. A non-volatile memory system comprising:
a memory controller comprising a first port configured to couple to a host device and a second port configured to couple a memory array;
wherein the memory controller is configured to
power-on the memory array upon control from the host device
identify an original logical block address (LBA) of the memory array to be read;
determine whether an LBA access count is greater than or equal to a predetermined count;
upon determining that the LBA access count is less than the predetermined count,
read the original LBA, and
increment an LBA access counter;
determine if the incremented LBA access count is greater than the predetermined count; and
upon determining that the incremented LBA access count is greater than the predetermined count, duplicate the data of the original LBA and store the duplicate data as backup data.

19. The system of claim 18, wherein the memory controller is configured to store the duplicate data as backup data by storing the duplicate data in one of a single-level cell (SLC) block, a triple-level cell (TLC) block, and a quad-level cell (QLC) block.

20. The system of claim 18, wherein the memory controller is further configured to duplicate data in one or more physical block addresses (PBAs) surrounding the original LBA and store the duplicated data of the one or more PBAs as backup data.

21. A method of addressing read-induced errors, the method comprising:
powering-on a memory device and identifying an original logical block address (LBA) to be read;
determining whether an LBA access count is greater than or equal to a predetermined count;
upon determining that the LBA access count is less than the predetermined count:
reading the original LBA, and
incrementing an LBA access counter by one.
determining if the incremented LBA access count is greater than the predetermined count; and
upon determining that the incremented LBA access count is greater than the predetermined count, outputting instructions to a host to perform at least one of:
a refresh of a Basic Input/Output System (BIOS) boot sector; and
a BIOS update.
